(19) United States
(12) Patent Application Publication
(10) Pub. No.: US 2003/0211863 A1
(43) Pub. Date: Nov. 13, 2003

(54) Accumulator with reading device

(76) Inventor: Wolfgang Neifer, Freising (DE)

Correspondence Address: FINNEGAN, HENDERSON, FARABOW, GARRETT & DUNNER, LLP, 1300 I STREET, NW, WASHINGTON, DC, 20005, US

(21) Appl. No.: 10/297,059

(22) PCT Filed: Jun. 1, 2001
(86) PCT No.: PCT/EP01/06302

(30) Foreign Application Priority Data
Jun. 2, 2000 (DE) 200 09 885.3

(51) Int. Cl. H04B 7/00

(52) U.S. Cl. 455/556.1; 455/517

(57) ABSTRACT

An accumulator with a reading device comprises a transmitting/receiving device (16) for wireless transmission of data between the reading device and a host device.

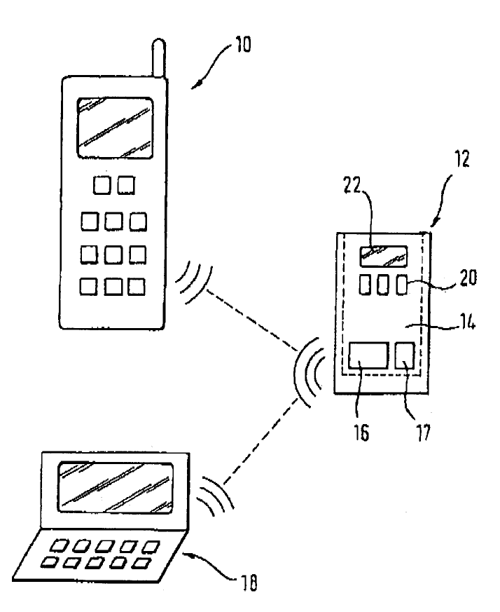

The invention relates to an accumulator with a reading device. As reading devices, generally those deices aye considered which-read out stored data and provide it for anther use or processing. One example of suck a reading device is a chip card reader.

Owing to their diverse functionality, chip cards are increasingly being used in more and more fields of everyday life. For example, chip cards serve as a data storage means, as a means of authentication for granting access to security-relevant data and functions (banking business etc.), as a means for signing documents or as a carrier of electronic purses. The chip card readers required for providing the data stored, on the chip of the chip card are expediently either connected as peripheral equipment to a host device in which the data is further processed, or directly accommodated in this host device. In the latter case the chip card reader utilizes the power supply of the host device. The band to the host device in either case prevents greater flexibility in using the chip card reader, in particular in view of a mobile use of the chip card reader or of the host device.

The invention however solves this problem not only with respect to a chip card reader, which has been picked out merely as an example of a reading device. Rather, the invention offers far-reaching advantages to all reading devices taken into consideration which may be accommodated in an accumulator according to the invention and are able to read out a suitable storage medium. These include more particularly reading devices for SIM cards in the use of mobile phones or for storage components arranged on respective memory cards.

The invention allows a spatial separation of the reading device from its host device, so that the devices ca be operated largely independently of the respective current location of the counterpart. According to the invention, an accumulator with a reading device comprises a transmitting/receiving device for wireless transmission of data between the reading device and a host devise. The invention is based on the realization that an operation of the reading device spatially separated from the host device is possible when the reading device, on the one hand, has a power supply at its disposal and, on the other hand, is in radio communication with the host device. The invention thereby gives a substantially extended leeway in the use of the reading device without requiring any structural changes to the host device. The only prerequisite is that the host device includes a suitable transmitter/receiver device via which it can communicate with the reading device. Then either a regular accumulator (without chip card reader) or the accumulator with the reading device in accordance with the invention can be inserted into the host device.

Preferred configurations of the accumulator in accordance with the invention are set forth in the subclaims.

Further features and advantages of the invention will be apparent from the following description and from the drawing to which reference is made. The single FIGURE of the drawing schematically shows an example of application of an accumulator of the invention.

A mobile phone 10 as host device is equipped with an accumulator 12 adapted to be inserted therein and supplying the mobile phone 10 with power via contacts provided specially for this purpose. The accumulator 12 includes a chip card reader 14 as reading device which is detachable from the accumulator 12 and, as will be explained in greater detail below, resorts directly or indirectly to the power supply of the accumulator 12.

The chip card reader 14 is, for example, used to carry out security-relevant operations by means of the mobile phone 1, for which an authentication is required. With the aid of the chip card reader 14 the carrier of a corresponding chip card can be identified as an authorized person by the data read from the chip card being passed on by the mobile phone 10, as the host device, to an appropriate place for evaluation. The data may however also be evaluated in a different way.

As shown in the FIGURE, the accumulator 12 is provided with a transmitting/receiving device 16 for wireless transmission of data, which is tuned to a corresponding transmitting/receiving device within the mobile phone 10. The two transmitting/receiving devices may be miniaturized microdevices, for example, which are configured according to the so-called Bluetooth standard. Accordingly, the chip card reader 14 within the accumulator 12 can be operated in conjunction with the mobile phone 10 even when the accumulator 12 is not inserted in the mobile phone 10. In this case the mobile phone 10 is powered by a regular substitute accumulator,(without chip card reader), while the accumulator 12 with the chip card reader 14 communicates by radio with the mobile phone 10 by means of the transmitting/receiving devices. The configuration of the transmitting/receiving devices dictates-the distance (which may be dependent on obstacles) over which the chip card reader 14 can be controlled by the mobile phone 10.

In the embodiment of the accumulator 12 shown in the FIGURE the transmitter/receiver device 16 for wireless transmission of data is accommodated on the chip card reader 14. The chip card reader 14 is further provided with a power supply 17 of its own. It is possible to design the power supply 17 as a “secondary” accumulator which can be charged by the accumulator 12. The power supply 17 of te chip card reader 14 may also be a detachable part of the accumulator 12 itself (back pack) which can be charged together with the accumulator 12. Provided with its own power supply 17, the chip card reader 14 remains operational even when it is detached from the accumulator. Since the transmitting/receiving device 16 is accommodated on the chip card reader 141 the transmission of data between the host device and the chip card reader 14 for controlling the chip card reader 14 and for providing the data read can thus be performed independently of the accumulator 12 for a limited period of time.

An even more flexible use of the chip card reader 14 results in that a connection can bc established via tee transmitting/receiving device 16 of the accumulator 12 to further devices 18 such as a further mobile phone, a car phone or a portable computer of the same owner, in addition to the mobile phone 10 as host device. Irrespective of whether the accumulator 12 is inserted in the host device or not, the chip card reader 14 of the accumulator 12 can additionally communicate with the further devices 18 and can be used by them.

The accumulator 12 has a serial interface which is alternatively connected to the chip card reader 14 or to the transmitting/riving device 16 of the accumulator. The switchover is done by a control function of the host device. In addition, the accumulator 12 can be charged via a line assigned to the serial interface.

A keyboard 20 in combination with a display device 22 on the accumulator 12 allows an individual programming and control of the chip card reader 14.

The transmitting/receiving device 16 of the accumulator 12 includes an embedded processor for security-relevant functions, which is separate from the data processing of the host device and is therefore tamper-proof.

An external recharging of the accumulator 12 is effected by inductive coupling, which is why the accumulator includes a coil suitable therefor.

A chip card reader as reading device is only one out of many examples of application of the present invention. If the reading device is a media player device such as a so-called MP3 player, for example, tt is used in combination with a mobile phone as host device, the pieces of music present as compressed data in the MP3 format can be listened to over the mobile phone, without the accumulator with the player device needing to be inserted in the mobile phone.

Likewise, the invention is not limited to a mobile phone as host device for the accumulator. In particular, a portable computer may be fitted with an accumulator according to the invention. The accumulator can be automatically charged in the known manner when the portable computer is mains operated.

1. An accumulator with a reading device, comprising a transmitting/receiving device (16) for wireless transmission of data between the reading device and a host device.

2. The accumulator according to claim 1, characterized in that the reading device is detachable from the accumulator (12).

3. The accumulator according to claim 2, characterized in that a power supply is accommodated on the reading device and that the transmitting/receiving device for wireless transmission of data is arranged on the reading device.

4. The accumulator according to any of the preceding claims, characterized in that it is adapted for the power supply of the host device and is adapted to be inserted therein.

5. The accumulator according to arty of the preceding claims, characterized in that the reading device is a chip card reader (14).

6. The accumulator according to any of the claims 1 to 4, characterized in that the reading device is adapted for reading out SIM cards.

7. The accumulator according to any of the claims 1 to 4, characterized in that the reading device is a media player device.

8. The accumulator according to any of the preceding claims, characterized in that the host device is a mobile phone (10).

9. The accumulator according to any of the claims 1 to 7, characterized in that the host device is a portable computer.

10. The accumulator according to any of the preceding claims, characterized in that transmitting/receiving device (16) is designed to communicate with further devices (18).

11. The accumulator according to any of the preceding claims, characterized in that it comprises a serial interface.

12. The accumulator according to claim 11, characterized in that the serial interface can be alternatively connected to the reading device or to the transmitting/receiving device (16).

13. The accumulator according to claim 12, characterized in that the connection of the serial interface can be switched over by a control function of the host device.

14. The accumulator according to any of the claims 11 to 13, characterized in that it can be charged via a line assigned to the serial interface.

15. The accumulator according to any of the preceding claims, characterized in that it comprises a keyboard (20) and a display device (22).

16. The accumulator according to any of the preceding claims, characterized in that the transmitting/receiving device (16) includes an embedded processor for security-relevant functions.

17. The accumulator according to any of the preceding claims, characterized in that it comprises a coil to charge the accumulator (12) by inductive coupling.

18. The accumulator according to any of the preceding claims, characterized in that the reading device is carried by the accumulator.

19. The accumulator according to any of the preceding claims, characterized in that the volume of the reading device is substantially smaller than that of the accumulator.

20. The accumulator according to any of the preceding claims, characterized in that the transmitting/receiving device (16) is a miniaturized microdevice according to the Bluetooth standard.
